(19) United States
(12) Patent Application Publication
(10) Pub. No.: US 2005/0267632 A1
(43) Pub. Date: Dec. 1, 2005

(54) Vehicle diagnosis robot

(75) Inventor: Hironori Waita, Wako (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: HONDA MOTOR CO., LTD.

(21) Appl. No.: 11/106,606

(22) Filed: Apr. 15, 2005

(30) Foreign Application Priority Data
May 13, 2004 (JP) 2004-143135

(51) Int. Cl. G06F 7/00; G06F 19/00

(52) U.S. Cl. 700/245

(57) ABSTRACT

A vehicle diagnosis robot of the invention comprises: an image taking unit (11) for taking an image of a portion of a vehicle to be inspected; an action generator (12) for generating an action required for the image taking unit to take an appropriate image of the portion of the vehicle; an information storage (14) for storing normal state information obtained from an image of the inspected portion of the vehicle in a normal state; means (17) for acquiring failure information by comparing current state information derived from a current image of the inspected portion of the vehicle taken by the image taking unit with the normal state information stored in the information storage; and information output means (15) for outputting the failure information acquired by the failure information acquiring means.

### TECHNICAL FIELD

The present invention relates to a vehicle diagnosis robot for conducting failure diagnosis on a vehicle to facilitate maintenance work.

### BACKGROUND OF THE INVENTION

In vehicle inspections (such as the inspections required by law or regular interval inspections) which are typically performed in service facilities of automobile dealers or the like, it is desirable to utilize an apparatus in conducting failure (or malfunction) diagnosis on a vehicle to assist maintenance work, whereby reducing the work load of maintenance personnel and improving the work efficiency.

As a conventional technique that utilizes an apparatus in vehicle failure diagnosis, it is known to use a remote server via Internet in performing vehicle failure diagnosis (see Japanese Patent Application Laid-Open (kokai) No. 2002-228552, for example) or to display the results of the vehicle diagnosis on a built-in monitor of the vehicle (see Japanese Patent Application Laid-Open (kokai) No. 2003-285701, for example). These conventional systems, however, utilize a self-diagnosis function incorporated in the vehicle, and therefore, the parts to be inspected are limited to those that can be checked by the self-diagnosis function.

On the other hand, it has been conceived to use an image taking unit or camera to take images of current state of the vehicle and carry out diagnosis using the images so that the diagnosis may not have to rely upon the vehicle's self-diagnosis function and can cover wider portions of the vehicle. In relation to such a technique that uses a camera to take images of the vehicle for use in vehicle diagnosis, Japanese Patent Application Laid-Open (kokai) No. 11-245729, for example, has disclosed taking images of a rear portion of the vehicle by a camera attached to the vehicle body. Also, Japanese Patent Application Laid-Open (kokai) No. 2002-067918 has disclosed a test system in which images of a rear portion of the vehicle obtained by a camera are displayed on a monitor placed in front of the vehicle.

However, in the case that the camera for taking images is attached to the vehicle body as disclosed in JPA Laid-Open No. 11-245729, the area that can be inspected by the camera may be limited to around the camera and thus it is impossible to inspect whole portions of the vehicle. In the test system disclosed in JPA Laid-Open No. 2002-067918, it may be possible to widen the inspected area by making the camera moveable. However, the test system of JPA Laid-Open No. 2002-067918 is large in size to such an extent that it surrounds the vehicle, and it is difficult to ensure a sufficient space for installing the system.

### BRIEF SUMMARY OF THE INVENTION

In view of such problems of the prior art, a primary object of the present invention is to provide a vehicle diagnosis robot that can perform vehicle failure diagnosis without relying upon the vehicle's self-diagnosis function so that various portions of the vehicle can be inspected substantially without limitation while eliminating the need for a large installation space.

According to the present invention, such objects can be accomplished by providing a vehicle diagnosis robot (1), comprising: an image taking unit (11) for taking an image of a portion of a vehicle to be inspected; an action generator (12) for generating an action required for the image taking unit to take an appropriate image of the portion of the vehicle; an information storage (14) for storing normal state information obtained from an image of the inspected portion of the vehicle in a normal state; means (17) for acquiring failure information by comparing current state information derived from a current image of the inspected portion of the vehicle taken by the image taking unit with the normal state information stored in the information storage; and information outputting means (15, 19) for outputting the failure information acquired by the failure information acquiring means.

Thus, because the robot can detect a visually recognizable failure from the images taken by the image taking unit and output the failure information, it is possible to perform failure diagnosis on various portions of the vehicle without relying upon the vehicle's self-diagnosis function. The robot can move to an appropriate position around the vehicle to take images of a desired portion of the vehicle, considerably reducing the restriction on the portions of the vehicle to be inspected. This also eliminates the need for ensuring a large installation space. Such a diagnosis robot of the invention can be embodied by furnishing a domestic robot with an appropriate program so that the user can personally and readily carry out inspection on the vehicle by using the robot.

Particularly, when it is necessary to operate some devices such as switches to inspect the operations of the related parts, the mobility of the robot is beneficial. For example, when the lamps on the rear side of the vehicle are inspected, the robot can move to a position facing the lamps on the rear of the vehicle to record and inspect the operations of the lamps while a worker can sit in the driver's seat and operate the devices related to the lamps. This can considerably improve the work efficiency.

The actions that may be generated by the action generator can include a traveling action for the robot to travel around the vehicle to move to a suitable position for taking images of the inspected portion of the vehicle and/or an imaging angle adjustment action for actuating the robot's head or the like where the image taking unit is incorporated, to make the image taking unit properly face the inspected portion. It is also possible for the robot to get in the vehicle to inspect the operations of display devices provided around the driver's seat such as the instrument panel.

The action generator can generate actions following the concrete commands provided from a worker or service person, such as “move forward” or the like. Alternatively, it is possible to pre-specify the portion(s) of the vehicle to be inspected by instructions from the worker or by a prescribed program while the robot processes the images from the image taking unit to locate the vehicle portion to be inspected and moves autonomously to a position for allowing the image taking unit to take images of the pre-specified portion of the vehicle.

The vehicle diagnosis robot may further comprise means (18) for acquiring repair information by accessing maintenance-manual information based on the failure information acquired by the failure information acquiring means to retrieve repair information, wherein the information output means outputs the repair information retrieved by the repair information acquiring means. This can make it possible to provide the worker on-site with the repair information that indicates the cause of failure and/or the process for repair work, whereby eliminating the need for the worker to refer to the maintenance manual and improving the repair work efficiency.

In the vehicle diagnosis robot of the present invention, the repair information acquiring means may access parts list information to retrieve identification information for specifying a replacement part or parts required for the repair. In this way, if the repair of the faulty vehicle portion requires replacement of some parts, the worker on-site can readily obtain the identification information, such as a management number, of the replacement parts. This can eliminate the need for the worker to refer to the parts list and thus improve the repair work efficiency.

Further, in the vehicle diagnosis robot of the present invention, the repair information acquiring means may access an inventory database to retrieve information regarding availability of a replacement part. In this way, if the repair of the faulty portion of the vehicle requires replacement of some parts, the worker on-site can readily obtain the information regarding the availability of the replacement parts such as inventory conditions, delivery time and prices, making it unnecessary for the worker to contact the personnel in charge of inventory management and thus improving the repair work efficiency.

In the above case, the inventory database may be a remote database such as that in a server maintained by the inventory management division of a vehicle manufacturing company or dealer.

The information output means of the vehicle diagnosis robot may comprise an audio output unit (15) for outputting an audio signal representing required information such as the failure information and/or repair information. The audio signal can provide the failure information and/or repair information in an easily understandable fashion. In such a case, the robot may be preferably configured to perform voice synthesis to convert text data into audio data so that the information is output as audio messages in a prescribed language.

Particularly, when it is necessary to operate some devices such as switches to check the operations of the related parts (e.g., rear lamps), the audio signal from the robot allows the worker operating the devices to recognize the operational state of the parts being checked, and therefore inspection work efficiency can be improved. If the robot is configured to produce vocal messages for instructing or prompting the worker to operate a certain device or devices, the work efficiency can be improved even further. Besides, in taking images of portions of the vehicle, the audio output unit may produce vocal messages for providing appropriate instructions such as “open the door” or “open the hood” to the worker.

In the vehicle diagnosis robot of the present invention, the information output means may comprise a wireless transmitter (19) for transmitting the required output information such as the failure information or repair information to a receiver (21) of the vehicle so that the received information can be output from output means (22) provided to the vehicle. In this way, the worker can be readily aware of the failure information and/or repair information provided from the output means of the vehicle. The output means of the vehicle may preferably comprise a monitor (22) for displaying the information or a loud speaker for providing the information as audio signals.

Particularly, when it is necessary to operate some devices such as switches to check the operations of the related parts (e.g., rear lamps) the images taken by the image taking unit can be preferably transmitted to the vehicle so that they are displayed on the monitor (image displaying means) situated in the vehicle to allow the worker operating the switches or the like to simultaneously recognize the operational state of the associated parts visually.

It may be also possible that the robot receives in a wireless fashion some vehicle information acquired by sensors and the like for the purpose of self-diagnosis of the vehicle, etc., and reflects the vehicle information on the failure diagnosis of the vehicle.

As described above, according to the present invention, because the robot can move to an appropriate position for taking images of a portion of the vehicle to be inspected and performs failure diagnosis based on the taken images, the diagnosis does not have to rely upon the vehicle's self-diagnosis function and various portions of the vehicle can be inspected substantially without limitation to find visually detectable failures. Such a mobile diagnosis robot can also avoid the necessity for ensuring a large installation space therefor.

Other and further objects, features and advantages of the invention will appear more fully from the following description.

### BRIEF DESCRIPTION OF THE DRAWINGS

Now the present invention is described in the following with reference to the appended drawings, in which:

FIG. 1 is a block diagram for schematically showing the configuration of a vehicle diagnosis robot according to the present invention;

FIG. 2 is a side view for showing the robot of FIG. 1 performing failure diagnosis on a vehicle; and

FIG. 3 is a flowchart showing a process performed by the robot of FIG. 1.

### DETAILED DESCRIPTION OF THE PREFERRED EMBODIMENTS

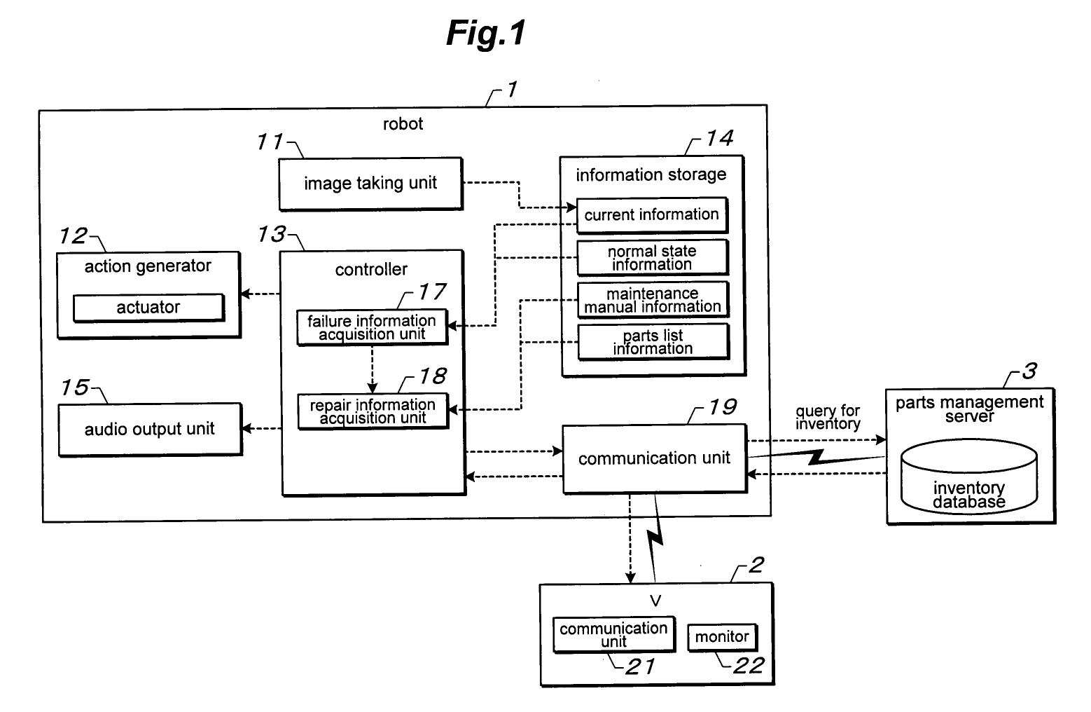

FIG. 1 is a block diagram schematically showing the configuration of a vehicle diagnosis robot according to the present invention. A robot 1 comprises: an image taking unit 11 for taking an image of a portion of a vehicle 2 to be inspected; an action generator 12 for generating necessary actions to allow the image taking unit 11 to take an appropriate image of the inspected portion; a controller 13 for conducting processes such as determination of presence or absence of a failure of the inspected portion based on the current image taken by the image taking unit 11; an information storage (memory) 14 for storing various information required for the controller 13 to conduct the processes; and an audio output unit (information output means) 15 for notifying the results of processes performed by the controller 13 to a worker.

The action generator 12 comprises an actuator or actuators for actuating the head, legs, arms, etc. of the robot 1 based upon control information produced in accordance with commands from the controller 13. The actions that may be generated by the action generator 12 can include a traveling action for the robot 1 to travel around the vehicle 2 to move to a suitable position for taking images of the inspected portion, and/or an imaging angle adjustment action for actuating the head or the like of the robot 1, where the image taking unit 11 is incorporated, to make the image taking unit 11 properly face the inspected portion. It should be noted that although it may be desirable for the robot 1 to have a human-like figure in order to facilitate taking images of various portions of the vehicle 2, the robot 1 may not be limited to a humanoid robot. For example, the robot 1 may have a traveling mechanism comprising wheels or endless belts instead of the bi-pedal walking mechanism.

In addition to taking images of the portions of the vehicle 2 to be inspected, the image taking unit 11 may continuously operate so that the continuously taken images can be properly processed by the robot 1 to obtain information on the circumstances around it. The image taking unit 11 preferably comprises a stereo camera having a pair of color CCDs (left and right), for example. Based on the parallax between the left and right images, the robot 1 can recognize the surrounding environment three-dimensionally, and in accordance with the acquired information, produces the control information for the actuators of the action generator 12 to make desired actions autonomously.

When taking the images of a portion of the vehicle to be inspected, the robot 1 can process the image information from the image taking unit 11 to detect the vehicle and locate the vehicle portion to be inspected, and autonomously make appropriate actions inclusive of moving to a position suitable for taking images of the vehicle portion. In this case, the portion or portions of the vehicle to be inspected may be pre-specified by instructions from a worker or alternatively by a prescribed program.

It may be also possible that an operator guides the robot 1 to a position suitable for taking images of the inspected vehicle portion by giving the robot 1 proper commands, such as “move forward,” “turn right,” etc., while watching the move of the robot 1. In such a case, the robot 1 preferably has a microphone for receiving vocal instructions from the operator and carries out voice recognition process thereon to convert the input audio data into text data to thereby identify the given instructions.

The controller 13 of the robot 1 comprises a failure information acquisition unit (means for acquiring failure information) 17 for determining whether or not there is a failure and if any, obtaining failure information for indicating a state of the failure. The controller 13 further comprises a repair information acquisition unit (means for acquiring repair information) 18 for, in response to detection of a failure, obtaining repair information regarding the cause for the failure, procedure for repair work, availability of repair parts, etc. The failure information acquisition unit 17 and the repair information acquisition unit 18 can be embodied by an electronic control unit (ECU) constituting the controller 13 and running a prescribed diagnosis program.

The failure information acquisition unit 17 compares current state information derived from a current image of the inspected portion of the vehicle taken by the image taking unit 11 with normal state information derived from a pre-taken image of the inspected portion in a normal (or original) state to obtain failure information for indicating presence/absence of a failure and a state of the failure. The normal state information functions as a reference in determining the presence/absence of a failure, and may be obtained beforehand in the normal state of the vehicle that meets the regarding laws/regulations and stored in the information storage 14.

The failure diagnosis in the failure information acquisition unit 17 can be achieved by comparing the unprocessed current and normal state images. However, it is also possible to use image recognition techniques to extract characteristic features in the images, and carry out the diagnosis by comparing the characteristic features between the current and normal state images. When checking the integrity of the lamps, for example, the characteristic features may comprise the color, brightness and positions of the lamps in an activated state.

The repair information acquisition unit 18 refers to maintenance manual information stored in the information storage 14 by using the failure information obtained by the failure information acquisition unit 17, to retrieve repair information for indicating the cause of the failure and the procedure for repair work. Further, the repair information acquisition unit 18 refers to parts list information in the information storage 14 to retrieve a management number (identification information) for specifying the repair part(s) necessary for replacing the faulty part(s).

The maintenance manual information contains information regarding the cause for failure and procedure for repair work in relation to the kinds or states of failure of various vehicle portions while the parts list information contains a list of management numbers for the repair parts mentioned in the maintenance manual information. Instead of storing the maintenance manual information and the parts list information in the information storage 14 serving as an internal storage of the robot 1, they may be stored in a remote server and accessed via a network or the like when necessary.

The audio output unit 15 outputs the information obtained at the controller 13 (specifically the failure information obtained at the failure information acquisition unit 17 and the repair information obtained at the repair information acquisition unit 18) as vocal messages in a prescribed language to convey the information to the worker. The audio output unit 15 performs voice synthesis to convert the output information consisting of text data into audio data which are output through a loud speaker as vocal sound representing desired information such as the failure information. Further, when it is necessary to operate some devices such as switches to check the operations of the related parts, such as when the lamps on the rear side of the vehicle are inspected, the audio output unit 15 can be used to produce an audio signal for instructing or prompting the worker to operate a certain device or devices.

The robot 1 further comprises a communication unit 19 for accessing an inventory database of a parts management server 3 to whereby allow the repair information acquisition unit 18 to retrieve the information regarding availability of the repair parts, such as inventory conditions, delivery time and price of the repair parts. The parts management server 3 may consist of a Web server that can be accessed via Internet, while the robot 1 may be connected to an access point to the Internet via wireless local area network (LAN).

Further, in order to provide the images taken by the image taking unit 11 to the worker in the driver's seat of the vehicle 2, the communication unit 19 can wirelessly transmit the signal containing desired information, such as the taken images, to a communication unit (receiver) 21 of the vehicle 2 so that the information derived from the received signal can be displayed on a monitor (output means) 22 in the vehicle 2. In this way, the images displayed on the monitor 22 allows the worker in the driver's seat to visually check the conditions of portions of the vehicle 2 that cannot be directly seen from the driver's seat. Further, the failure information obtained by the failure information acquisition unit 17 and the repair information obtained by the repair information acquisition unit 18 can be also transmitted as text data and/or image data (still images or moving images) and displayed on the monitor 22 so that the worker can recognize the situation more precisely.

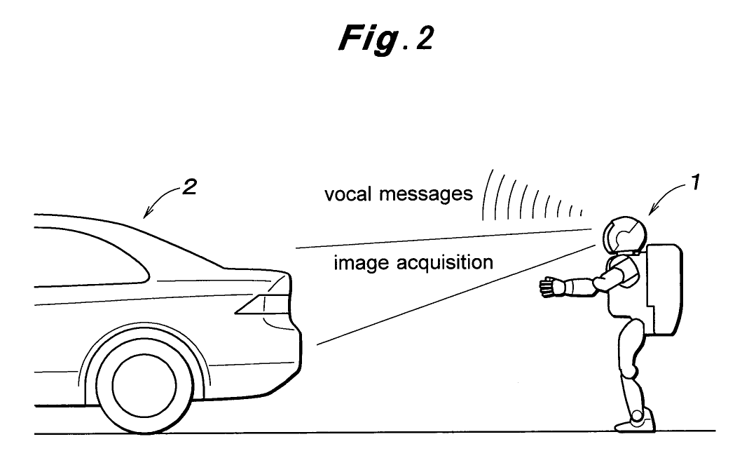

FIG. 2 is a schematic side view showing the robot 1 of FIG. 1 performing diagnosis on the vehicle 2. In this embodiment, inspection is performed on the lamps on the rear side of the vehicle 2, i.e., rear-mounted turn signal lamps (indicators), rear-mounted hazard lamps, stop lamps (brake lamps), reverse lamps, and license plate lamps.

The robot 1 moves to a position in the rear of the vehicle 2 from where it can take images of the rear lamps of the vehicle 2 while the worker sits in the driver's seat so that he/she can operate the devices such as the switches for the lamps and the shift lever. Then, the robot 1 produces vocal messages indicting operational instructions, such as “right,” “left,” “back” or “hazard,” and following the instructions from the robot 1, the worker operates appropriate devices while the robot 1 takes images of the lamps that operate in response to the operation of the devices by the worker. The robot 1 performs diagnosis using the taken images to detect failure and notifies the worker of presence/absence of failure and a state of failure if any through audio (vocal) signals.

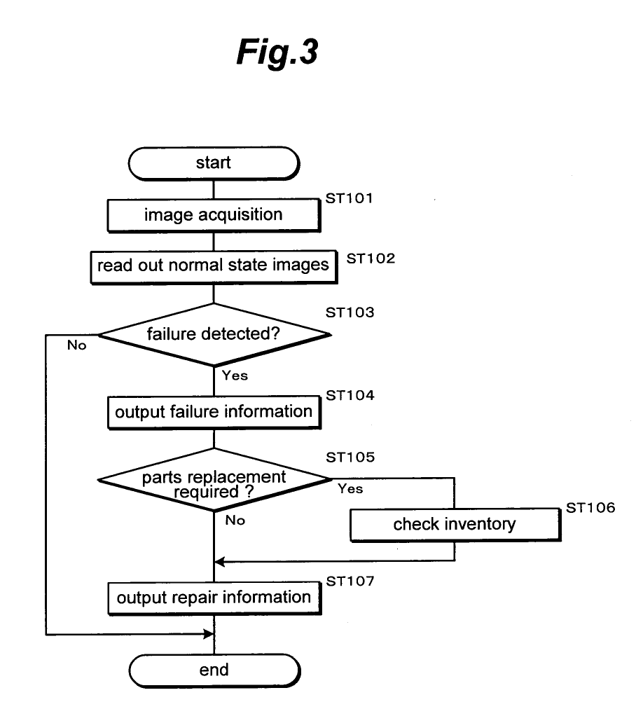

FIG. 3 is a flowchart showing the steps of a process performed in the robot 1 shown in FIG. 1. First, the robot 1 moves to a position for enabling it to take appropriate images of a portion of the vehicle 2 of interest and performs the image acquisition (step 101). Then, the failure information acquisition unit 17 of the controller 13 reads out the normal state information or normal state image (step 102), and compares it with the current state information (current image) to determine the presence/absence of a failure (step 103). If it is determined that a failure exists in step 103, failure information for indicating a state of failure is obtained and notified to the worker through the audio output unit 15 (step 104).

Subsequently, the repair information acquisition unit 18 of the controller 13 accesses the maintenance manual information by using the failure information to determine if a repair part is necessary or not (step 105). If it is determined in step 105 that a repair part is necessary, the parts management server 3 is accessed to check the inventory condition (step 106). Then, the repair information, i.e., the information showing the repair procedure based on the maintenance manual information, the management number of the repair part based on the parts list information, and the information regarding availability of the repair part, such as the price, delivery time and inventory condition of the repair part based on the inventory database, is retrieved and notified to the worker by the audio output unit 15.

The vehicle diagnosis robot according to the present invention has an advantage that it can perform failure diagnosis on various portions of the vehicle and does not require a substantial space therefor. Thus, the present invention is quite useful as a vehicle diagnosis robot for use in maintenance facilities or the like to help improve the efficiency in the maintenance work through facilitated vehicle diagnosis.

Although the present invention has been described; in terms of a preferred embodiment thereof, it is obvious to a person skilled in the art that various alterations and modifications are possible without departing from the scope of the present invention which is set forth in the appended claims.

For example, the normal state information or images can be stored for each of various portions of different types of vehicles with/without optional parts so that an appropriate normal state information (image) can be retrieved for a particular portion of a particular type of vehicle to be inspected. Further, the vehicle diagnosis robot according to the present invention can be used not only in maintenance service facilities of vehicle dealers but also in rent-a car providers to check the integrity of the returned vehicle.

1. A vehicle diagnosis robot, comprising:
an image taking unit for taking an image of a portion of a vehicle to be inspected;
an action generator for generating an action required for the image taking unit to take an appropriate image of the portion of the vehicle;
an information storage for storing normal state information obtained from an image of the inspected portion of the vehicle in a normal state;
means for acquiring failure information by comparing current state information derived from a current image of the inspected portion of the vehicle taken by the image taking unit with the normal state information stored in the information storage; and information output means for outputting the failure information acquired by the failure information acquiring means.

2. The vehicle diagnosis robot according to claim 1, further comprising means for acquiring repair information by accessing maintenance manual information based on the failure information acquired by the failure information acquiring means to retrieve repair information, wherein the information output means outputs the repair information retrieved by the repair information acquiring means.

3. The vehicle diagnosis robot according to claim 2, wherein the repair information acquiring means accesses parts list information to retrieve identification information for specifying a replacement part required for the repair.

4. The vehicle diagnosis robot according to claim 2, wherein the repair information acquiring means accesses an inventory database to retrieve information regarding availability of a replacement part.

5. The vehicle diagnosis robot according to claim 1, wherein the information output means comprises an audio output unit for outputting an audio signal representing the failure information.

6. The vehicle diagnosis robot according to claim 2, wherein the information output means comprises an audio output unit for outputting an audio signal representing the repair information.

7. The vehicle diagnosis robot according to claim 1, wherein the information output means comprises a wireless transmitter for transmitting the failure information to a receiver of the vehicle so that the received information can be output from output means provided to the vehicle.

8. The vehicle diagnosis robot according to claim 2, wherein the information output means comprises a wireless transmitter for transmitting the repair information to a receiver of the vehicle so that the received information can be output from output means provided to the vehicle.
